(19) United States
(12) Patent Application Publication
(10) Pub. No.: US 2024/0030570 A1
(43) Pub. Date: Jan. 25, 2024

(54) SECONDARY BATTERY

(71) Applicant: MURATA MANUFACTURING CO., LTD., Kyoto (JP)

(72) Inventors: Moriaki OKUNO, Kyoto (JP); Yoshiichi HORIKOSHI, Kyoto (JP); Taichi KATSUMOTO, Kyoto (JP)

(21) Appl. No.: 18/375,222

(22) Filed: Sep. 29, 2023

Related U.S. Application Data
(63) Continuation of application No. PCT/JP2021/047216, filed on Dec. 21, 2021.

(30) Foreign Application Priority Data
Mar. 31, 2021 (JP) 2021-060138

(51) Int. Cl. H01M 50/588; H01M 50/107; H01M 50/152; H01M 50/593; H01M 50/559; H01M 50/562; H01M 50/119; H01M 10/0525; H01M 4/58

(52) U.S. Cl. CPC H01M 50/588; H01M 50/107; H01M 50/152; H01M 50/593; H01M 50/559; H01M 50/562; H01M 50/119; H01M 10/0525; H01M 4/5825; H01M 2004/028

(57) ABSTRACT

A secondary battery includes an outer package member, a battery device, an electrode terminal, and an insulating member. The outer package member has a through hole. The battery device is contained inside the outer package member. The electrode terminal is disposed on an outer side of the outer package member and covers the through hole. The insulating member is disposed between the electrode terminal and the outer package member, and does not cover the through hole. The outer package member includes a container part having an opening and containing the battery device inside, and a cover part having the through hole and closing the opening. The container part and the cover part are joined to each other. The insulating member has a temperature of deflection under load ranging from 60° C. to 150° C. both inclusive. The cover part has a thickness smaller than a thickness of the container part.

### CROSS REFERENCE TO RELATED APPLICATIONS

The present application is a continuation of PCT patent application no. PCT/JP2021/047216, filed on Dec. 21, 2021, which claims priority to Japanese patent application no. 2021-060138, filed on Mar. 31, 2021, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

Specifically, a positive electrode and a negative electrode are housed in a battery case, and a resistance value measured upon bringing the positive electrode and the negative electrode into contact with each other after charging is defined. In this case, a positive electrode terminal coupled to the positive electrode is disposed at one end of the battery case, and a negative electrode terminal coupled to the negative electrode is disposed at another end of the battery case.

### SUMMARY

The present technology relates to a secondary battery.

Although consideration has been given in various ways in relation to a configuration of a secondary battery, safety of the secondary battery still remains insufficient. Accordingly, there is room for improvement in terms thereof. It is therefore desirable to provide a secondary battery that makes it possible to achieve superior safety.

A secondary battery according to an embodiment of the present technology includes an outer package member, a battery device, an electrode terminal, and an insulating member. The outer package member has a through hole. The battery device is contained inside the outer package member. The electrode terminal is disposed on an outer side of the outer package member and covers the through hole. The insulating member is disposed between the electrode terminal and the outer package member, and does not cover the through hole. The outer package member includes a container part and a cover part. The container part has an opening and contains the battery device inside. The cover part has the through hole and closes the opening. The container part and the cover part are joined to each other. The insulating member has a temperature of deflection under load of greater than or equal to 60° C. and less than or equal to 150° C. The cover part has a thickness smaller than a thickness of the container part.

Here, a method of measuring the temperature of deflection under load is in accordance with JIS K7191-2. Details of the method of measuring the temperature of deflection under load will be described later.

According to the secondary battery of an embodiment, the battery device is contained inside the outer package member having the through hole, the electrode terminal disposed on the outer side of the outer package member covers the through hole, the insulating member disposed between the electrode terminal and the outer package member does not cover the through hole, the outer package member includes the container part and the cover part joined to each other, the insulating member has the temperature of deflection under load of greater than or equal to 60° C. and less than or equal to 150° C., and the cover part is smaller than the container part in thickness. Accordingly, it is possible to achieve superior safety.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of a secondary battery according to an embodiment of the present technology.

FIG. 2 is an enlarged sectional view of a configuration of a battery device illustrated in FIG. 1.

FIG. 3 is a sectional diagram for describing dimensional conditions of the secondary battery.

FIG. 4 is a sectional diagram for describing an operation of the secondary battery.

FIG. 5 is a sectional diagram for describing a method of manufacturing the secondary battery.

FIG. 6 is a sectional view of a configuration of a secondary battery of a first comparative example.

FIG. 7 is a sectional view of a configuration of a secondary battery of a second comparative example.

FIG. 8 is a sectional view of a configuration of a secondary battery of an embodiment.

FIG. 9 is a sectional view of a configuration of a secondary battery of an embodiment.

FIG. 10 is a sectional view of a configuration of a secondary battery of an embodiment.

FIG. 11 is a block diagram illustrating a configuration of an application example of the secondary battery.

### DETAILED DESCRIPTION

One or more embodiments of the present technology are described below in further detail including with reference to the drawings.

A description is given first of a secondary battery according to an embodiment of the present technology.

The secondary battery to be described here has a columnar three-dimensional shape. As will be described later, the secondary battery includes two bottom parts opposed to each other, and a sidewall part coupled to each of the two bottom parts.

Here, the secondary battery is of what is called a cylindrical type, and has a height greater than an outer diameter. The “outer diameter” is a diameter (a maximum diameter) of each of the two bottom parts. The “height” is a distance (a maximum distance) from one of the bottom parts to another of the bottom parts.

Although a charge and discharge principle of the secondary battery is not particularly limited, the following description deals with a case where a battery capacity is obtained through the use of insertion and extraction of an electrode reactant. The secondary battery includes a positive electrode, a negative electrode, and an electrolyte. In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery that obtains the battery capacity through the use of insertion and extraction of lithium is what is called a lithium-ion secondary battery. In the lithium-ion secondary battery, lithium is inserted and extracted in an ionic state.

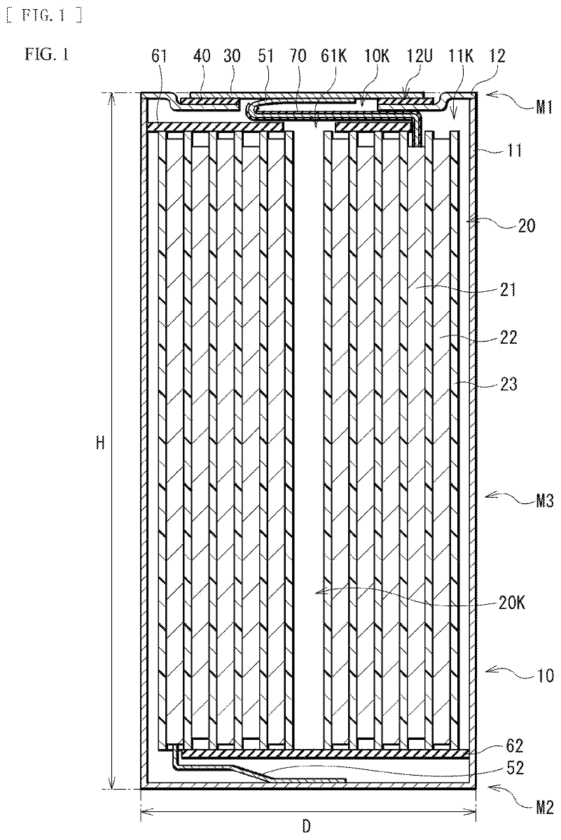

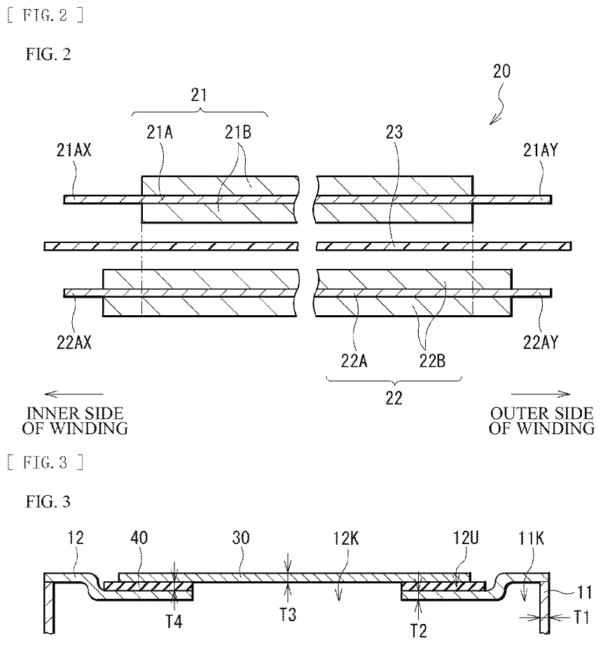

FIG. 1 illustrates a sectional configuration of the secondary battery. FIG. 2 illustrates an enlarged sectional configuration of a battery device 20 illustrated in FIG. 1.

Note that, to facilitate understanding of the configuration of the battery device 20, FIG. 2 illustrates a state where a positive electrode 21, a negative electrode 22, and a separator 23 each extend from an inner side of winding toward an outer side of the winding, and where the positive electrode 21, the negative electrode 22, and the separator 23 are separated from each other.

In the following description, for convenience, an upper side of FIG. 1 is taken as an upper side of the secondary battery, and a lower side of FIG. 1 is taken as a lower side of the secondary battery.

The secondary battery of the cylindrical type to be described here has, as illustrated in FIG. 1, a three-dimensional shape in which a height H is greater than an outer diameter D, that is, a cylindrical (circular columnar) three-dimensional shape.

Dimensions of the secondary battery are not particularly limited; however, by way of example, the outer diameter D is within a range from 14 mm to 26 mm both inclusive, and the height H is within a range from 49 mm to 70 mm both inclusive. Note that a ratio D/H of the outer diameter D to the height H is less than 1. A lower limit of the ratio D/H is specifically 0.28, but is not particularly limited thereto.

As illustrated in FIGS. 1 and 2, the secondary battery includes an outer package can 10, the battery device 20, an external terminal 30, a gasket 40, a positive electrode lead 51, a negative electrode lead 52, a pair of insulating plates 61 and 62, and a sealant 70.

As illustrated in FIG. 1, the outer package can 10 is a hollow outer package member to contain the battery device 20 and other components therein, and has a through hole 10K.

Here, the outer package can 10 has a cylindrical three-dimensional shape corresponding to the three-dimensional shape of the secondary battery that is cylindrical. Accordingly, the outer package can 10 includes an upper bottom part M1 and a lower bottom part M2 opposed to each other, and a sidewall part M3. The sidewall part M3 is located between the upper bottom part M1 and the lower bottom part M2 and coupled to each of the upper bottom part M1 and the lower bottom part M2. Here, the upper bottom part M1 and the lower bottom part M2 are each circular in plan shape, and a surface of the sidewall part M3 is a curved surface that is convex outward.

The outer package can 10 includes a container part 11 and a cover part 12 that are joined to each other. The container part 11 is sealed by the cover part 12. Here, as will be described later, the container part 11 and the cover part 12 are welded to each other.

The container part 11 is a substantially container-shaped member having a cylindrical shape, and contains the battery device 20 and other components inside. The container part 11 corresponds to the lower bottom part M2 and the sidewall part M3. Here, the container part 11 has a structure in which the lower bottom part M2 and the sidewall part M3 are integrated with each other. The container part 11 has a hollow structure with an upper end open and a lower end closed, and thus has an opening 11K in the upper end.

The cover part 12 is a substantially disk-shaped member that closes the opening 11K. The cover part 12 corresponds to the upper bottom part M1, and has the through hole 10K described above. As will be described later, the through hole 10K is used as a coupling path for coupling the battery device 20 and the external terminal 30 to each other, and as a transfer path of heat to the gasket 40.

Here, the cover part 12 includes a recessed part 12U. At the recessed part 12U, the cover part 12 is so bent as to be partly recessed toward an inside of the container part 11. Accordingly, a portion of the cover part 12 is so bent as to form a downward step. The through hole 10K is provided in the recessed part 12U.

A shape of the recessed part 12U, that is, a shape defined by an outer edge of the recessed part 12U as viewed from above the secondary battery is not particularly limited. Here, the recessed part 12U has a circular shape. An inner diameter and a depth of the recessed part 12U are not particularly limited, and may be set to any values.

As described above, the outer package can 10 includes two members (the container part 11 and the cover part 12) that have been physically separate from each other and are welded to each other. The outer package can 10 is thus of a type that is what is called a welded can. Accordingly, the outer package can 10 is physically a single member as a whole, and is in a state of being not separable into the two members (the container part 11 and the cover part 12) afterward.

The outer package can 10 as a welded can is different from a crimped can formed by means of crimping processing, and is thus what is called a crimpless can. A reason for employing the crimpless can is that this increases a device space volume inside the outer package can 10, and accordingly increases an energy density per unit volume. The “device space volume” refers to a volume (an effective volume) of an internal space of the outer package can 10 available for containing the battery device 20 therein.

Further, the outer package can 10 as a welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable afterward.

Here, the outer package can 10 is electrically conductive, and each of the container part 11 and the cover part 12 is thus electrically conductive. The outer package can 10 is electrically coupled to the battery device 20 (the negative electrode 22 to be described later) via the negative electrode lead 52. The outer package can 10 thus serves as an external coupling terminal for the negative electrode 22. A reason for employing such a configuration is that this makes it unnecessary for the secondary battery to be provided with an external coupling terminal for the negative electrode 22 separate from the outer package can 10, and thus suppresses a decrease in device space volume resulting from providing the external coupling terminal for the negative electrode 22. As a result, the device space volume increases, and accordingly, the energy density per unit volume increases.

Specifically, the outer package can 10 includes one or more of electrically conductive materials including, without limitation, a metal material and an alloy material. Examples of the electrically conductive materials include iron, copper, nickel, stainless steel, an iron alloy, a copper alloy, and a nickel alloy. Although the stainless steel is not particularly limited in kind, specific examples of the stainless steel include SUS304 and SUS316. Note that the container part 11 and the cover part 12 may include the same material, or may include respective different materials.

As will be described later, the cover part 12 is insulated, via the gasket 40, from the external terminal 30 serving as an external coupling terminal for the positive electrode 21. A reason for this is that this prevents contact (a short circuit) between the outer package can 10 (the external coupling terminal for the negative electrode 22) and the external terminal 30 (the external coupling terminal for the positive electrode 21).

Although not particularly limited, a thermal conductivity (W/m·K) of the cover part 12 is preferably higher than a thermal conductivity (W/m·K) of the gasket 40, in particular. A reason for this is that in such a case, upon heat generation of the battery device 20, it becomes easier for the heat generated at the battery device 20 to be transferred to the gasket 40 via the cover part 12, and it thus becomes easier for the external terminal 30 to operate as a heat-actuated open/close valve. Details of the external terminal 30 operating as the heat-actuated open/close valve will be described later.

The battery device 20 is a power generation device that causes charging and discharging reactions to proceed, and is contained inside the outer package can 10 as illustrated in FIG. 1. The battery device 20 includes the positive electrode 21, the negative electrode 22, and the separator 23, as illustrated in FIG. 2. The battery device 20 further includes an unillustrated electrolytic solution that is a liquid electrolyte.

The battery device 20 to be described here is what is called a wound electrode body. That is, in the battery device 20, the positive electrode 21 and the negative electrode 22 are stacked on each other with the separator 23 interposed therebetween, and the stack of the positive electrode 21, the negative electrode 22, and the separator 23 is wound. The positive electrode 21 and the negative electrode 22 are thus opposed to each other with the separator 23 interposed therebetween, and are wound. As a result, the battery device 20 has a winding center space 20K that is a winding core part. Here, the positive electrode 21, the negative electrode 22, and the separator 23 are so wound as to allow the negative electrode 22 to be disposed in an outermost wind.

The battery device 20 has a three-dimensional shape similar to the three-dimensional shape of the outer package can 10. The battery device 20 thus has a cylindrical three-dimensional shape. A reason for this is that this helps to prevent a dead space, i.e., a surplus space between the outer package can 10 and the battery device 20, from developing easily when the battery device 20 is placed inside the outer package can 10, and thus allows for efficient use of the internal space of the outer package can 10, as compared with a case where the battery device 20 has a three-dimensional shape different from the three-dimensional shape of the outer package can 10. As a result, the device space volume increases, and accordingly, the energy density per unit volume increases.

As illustrated in FIG. 2, the positive electrode 21 includes a positive electrode current collector 21A and a positive electrode active material layer 21B.

The positive electrode current collector 21A is an electrically conductive support that supports the positive electrode active material layer 21B. The positive electrode current collector 21A has two opposed surfaces on each of which the positive electrode active material layer 21B is provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A, on a side where the positive electrode 21 is opposed to the negative electrode 22. The positive electrode active material layer 21B may further include one or more of other materials including, without limitation, a positive electrode binder and a positive electrode conductor. A method of forming the positive electrode active material layer 21B is not particularly limited, and specific examples thereof include a coating method.

The positive electrode active material includes a lithium compound. A reason for this is that a high energy density is obtainable. The lithium compound is a compound that includes lithium as a constituent element, and more specifically, a compound that includes lithium and one or more transition metal elements as constituent elements. Note that the lithium compound may further include one or more of other elements, i.e., elements other than lithium and transition metal elements.

Although not particularly limited in kind, the lithium compound is specifically an oxide, a phosphoric acid compound, a silicic acid compound, or a boric acid compound, for example. A crystal structure of the lithium compound is not particularly limited, and specific examples thereof include a layered rock-salt crystal structure, a spinel crystal structure, and an olivine crystal structure.

Specific examples of the oxide having the layered rock-salt crystal structure include LiNiO₂ and LiCoO₂. Specific examples of the oxide having the spinel crystal structure include LiMn₂O₄. Specific examples of the phosphoric acid compound having the olivine crystal structure include LiFePO₄ and LiMnPO₄.

The positive electrode 21 preferably includes the positive electrode active material having the olivine crystal structure, in particular. The lithium compound is thus preferably a phosphoric acid compound having the olivine crystal structure. A reason for this is that this improves safety of the secondary battery. In more detail, this makes it less easy for lithium to be extracted from the positive electrode 21 even upon overcharging of the secondary battery, thus helping to prevent the negative electrode 22 from being excessively charged easily. Further, it becomes less easy for the positive electrode 21 to generate heat upon a thermal runaway of the secondary battery, which helps to prevent the secondary battery from excessively increasing in temperature and to prevent a gas associated with, for example, a decomposition reaction of the electrolytic solution from being generated easily.

More specifically, the lithium compound is preferably an iron-based phosphoric acid compound represented by Formula (1) below. A reason for this is that in such a case, the safety of the secondary battery sufficiently improves.

LiFeₓM_{y}PO₄ (1)
where:
M is any one or more of Nb, Ni, Mg, Ti, Zn, Zr, Ta, W, Mo, Mn, or Co; and
x and y satisfy 0.5<x≤1 and 0≤y<0.5.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

Here, as illustrated in FIG. 2, the positive electrode active material layer 21B is provided on only a portion of the positive electrode current collector 21A in a winding direction, that is, a lateral direction in FIG. 2. More specifically, the positive electrode active material layer 21B is provided on only a middle part of the positive electrode current collector 21A in the winding direction. Accordingly, the positive electrode current collector 21A includes an exposed part 21AX and an exposed part 21AY each of which is not covered with the positive electrode active material layer 21B. The exposed part 21AX is an end part of the positive electrode current collector 21A on the inner side of the winding. The exposed part 21AY is an end part of the positive electrode current collector 21A on the outer side of the winding.

As illustrated in FIG. 2, the negative electrode 22 includes a negative electrode current collector 22A and a negative electrode active material layer 22B.

The negative electrode current collector 22A is an electrically conductive support that supports the negative electrode active material layer 22B. The negative electrode current collector 22A has two opposed surfaces on each of which the negative electrode active material layer 22B is provided. The negative electrode current collector 22A includes an electrically conductive material such as a metal material. Examples of the metal material include copper.

Here, the negative electrode active material layer 22B is provided on each of the two opposed surfaces of the negative electrode current collector 22A. The negative electrode active material layer 22B includes one or more of negative electrode active materials into which lithium is insertable and from which lithium is extractable. Note that the negative electrode active material layer 22B may be provided only on one of the two opposed surfaces of the negative electrode current collector 22A, on a side where the negative electrode 22 is opposed to the positive electrode 21. The negative electrode active material layer 22B may further include any of other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both, for example. A reason for this is that a high energy density is obtainable. Examples of the carbon material include graphitizable carbon, non-graphitizable carbon, and graphite (natural graphite and artificial graphite). The metal-based material is a material that includes, as a constituent element or constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, as illustrated in FIG. 2, the negative electrode active material layer 22B is provided on only a portion of the negative electrode current collector 22A in the winding direction, that is, the lateral direction in FIG. 2. More specifically, the negative electrode active material layer 22B is provided on only a middle part of the negative electrode current collector 22A in the winding direction. Accordingly, the negative electrode current collector 22A includes an exposed part 22AX and an exposed part 22AY each of which is not covered with the negative electrode active material layer 22B. The exposed part 22AX is an end part of the negative electrode current collector 22A on the inner side of the winding. The exposed part 22AY is an end part of the negative electrode current collector 22A on the outer side of the winding.

Here, the positive electrode 21 and the negative electrode 22 are so wound as to allow the negative electrode 22 to be disposed in the outermost wind, as described above. In this case, the exposed part 22AY is not coupled to the outer package can 10 but is separated from the outer package can 10.

Note that the negative electrode active material layer 22B has a length greater than a length of the positive electrode active material layer 21B. The “length” described here refers to a dimension in the winding direction. The same applies to the description below. In this case, the negative electrode active material layer 22B is extended toward the inner side of the winding more than the positive electrode active material layer 21B and toward the outer side of the winding more than the positive electrode active material layer 21B. This is to prevent lithium ions extracted from the positive electrode 21 from precipitating on the surface of the negative electrode 22.

The separator 23 is an insulating porous film interposed between the positive electrode 21 and the negative electrode 22, as illustrated in FIG. 2. The separator 23 allows lithium ions to pass therethrough while preventing contact (a short circuit) between the positive electrode 21 and the negative electrode 22. The separator 23 includes a polymer compound such as polyethylene.

Note that the separator 23 has a length greater than a length of each of the positive electrode 21 and the negative electrode 22. In this case, the separator 23 is extended toward the inner side of the winding more than each of the positive electrode 21 and the negative electrode 22, and toward the outer side of the winding more than each of the positive electrode 21 and the negative electrode 22. This is to prevent a short circuit between the positive electrode 21 and the negative electrode 22.

The electrolytic solution includes a solvent and an electrolyte salt. The positive electrode 21, the negative electrode 22, and the separator 23 are each impregnated with the electrolytic solution. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is what is called a non-aqueous electrolytic solution. The electrolyte salt includes one or more of light metal salts including, without limitation, a lithium salt.

As illustrated in FIG. 1, the external terminal 30 is an electrode terminal to be coupled to electronic equipment when the secondary battery is mounted on the electronic equipment. The external terminal 30 is disposed on an outer side of the outer package can 10 and covers the through hole 10K.

The external terminal 30 is supported by the outer package can 10 via the gasket 40. More specifically, as will be described later, the external terminal 30 is thermally welded to the cover part 12 via the gasket 40. The external terminal 30 is thus fixed to the cover part 12 via the gasket 40 and insulated from the cover part 12 via the gasket 40.

Here, the external terminal 30 is electrically coupled to the battery device 20 (the positive electrode 21 described above) via the positive electrode lead 51. The external terminal 30 thus serves as the external coupling terminal for the positive electrode 21. Accordingly, upon use of the secondary battery, the secondary battery is coupled to electronic equipment via the external terminal 30 (the external coupling terminal for the positive electrode 21) and the outer package can 10 (the external coupling terminal for the negative electrode 22). This allows the electronic equipment to operate with use of the secondary battery as a power source.

The external terminal 30 is a substantially plate-shaped member. Although not particularly limited, a three-dimensional shape of the external terminal 30 is specifically a flat plate shape.

Here, the external terminal 30 is disposed inside the recessed part 12U. More specifically, the external terminal 30 is so placed inside the recessed part 12U as not to protrude outward relative to the recessed part 12U. A reason for this is that this reduces the height H of the secondary battery and thus increases the energy density per unit volume, as compared with a case where the external terminal 30 protrudes outward relative to the recessed part 12U.

Note that the external terminal 30 has an outer diameter smaller than an inner diameter of the recessed part 12U. The external terminal 30 is thus separated from the cover part 12 surrounding the external terminal 30. Accordingly, the gasket 40 is disposed only in a portion of a space between the cover part 12 and the external terminal 30 inside the recessed part 12U. More specifically, the gasket 40 is disposed only at a location where the cover part 12 and the external terminal 30 would be in contact with each other if it were not for the gasket 40.

The external terminal 30 includes any one or more of electrically conductive materials including, without limitation, a metal material and an alloy material. Examples of the electrically conductive materials include aluminum and an aluminum alloy. A reason for employing such a material is that the external terminal 30 improves in thermal conductivity. This makes it easier for heat generated at the battery device 20 to be transferred to the gasket 40 via the external terminal 30, thus making it easier for the external terminal 30 to operate as the heat-actuated open/close valve. Another reason is that a reduction in weight of the external terminal 30 is achievable. This allows for an increase in energy density per weight of the secondary battery.

Note that the external terminal 30 may include a cladding material. The cladding material includes an aluminum layer and a nickel layer that are disposed in this order from a side closer to the gasket 40. The aluminum layer and the nickel layer are roll-bonded to each other. Note that the cladding material may include a nickel alloy layer instead of the nickel layer.

In particular, the external terminal 30 serves as a release valve to release an internal pressure of the outer package can 10 upon an increase in the internal pressure. Examples of a cause of the increase in the internal pressure include generation of a gas due to a decomposition reaction of the electrolytic solution during charging and discharging. Examples of a factor accelerating the decomposition reaction of the electrolytic solution include an internal short circuit of the secondary battery, heating of the secondary battery, and discharging of the secondary battery under a large current condition.

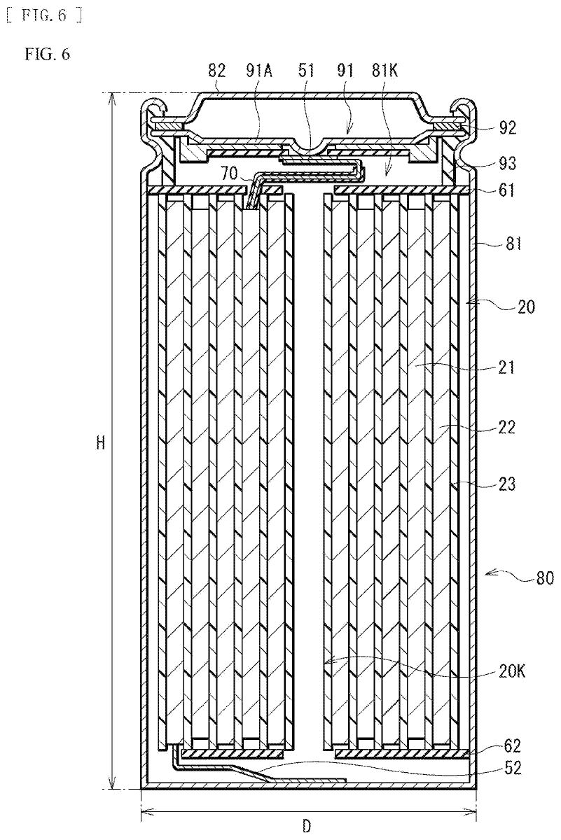

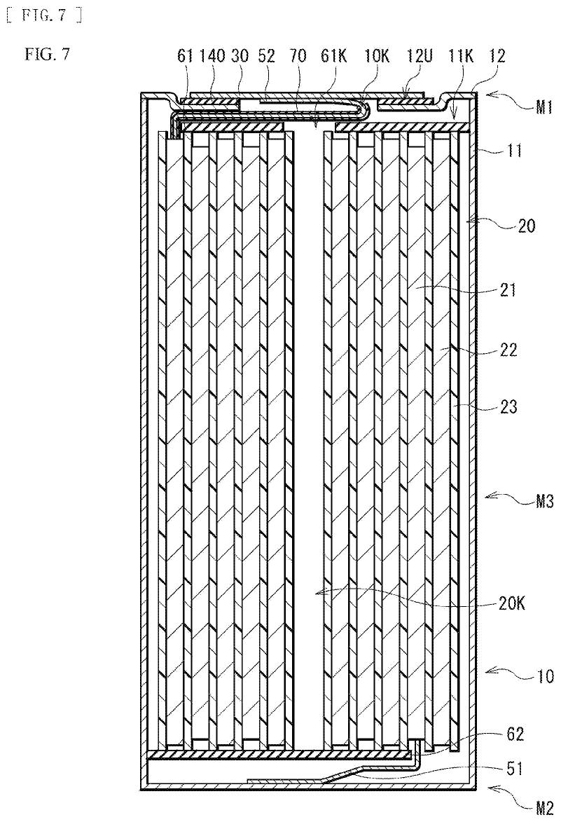

In contrast to a safety valve mechanism 91 (see FIG. 6) that serves as a pressure-actuated release valve to be described later, the external terminal 30 serves as the heat-actuated release valve. That is, the external terminal 30 serving as the heat-actuated open/close valve is actuated in response to an increase in internal temperature of the outer package can 10, not in response to an increase in the pressure inside the outer package can 10. In contrast, the safety valve mechanism 91 serving as the pressure-actuated release valve is actuated in response to an increase in the pressure inside the outer package can 10, not in response to an increase in the internal temperature of the outer package can 10.

Specifically, the external terminal 30 is thermally welded to the cover part 12 via the gasket 40, as described above. As a result, in normal times, the external terminal 30 is fixed to the cover part 12 via the gasket 40 and thus covers the through hole 10K. That is, the outer package can 10 is sealed and accordingly, the battery device 20 is sealed in the outer package can 10.

In contrast, upon the occurrence of an abnormal condition, that is, upon an excessive increase in the internal temperature of the outer package can 10 due to heat generation of the battery device 20, the gasket 40 is heated by the heat generated at the battery device 20, which results in thermal deformation of the gasket 40. In such a case, the heat generated at the battery device 20 is conducted to each of the cover part 12 and the external terminal 30, and accordingly, the gasket 40 is heated via each of the cover part 12 and the external terminal 30. Examples of a factor causing heat generation of the battery device 20 include charging of the secondary battery under the large current condition and overcharging of the secondary battery.

This results in a decrease in fixation strength (seal strength) of the external terminal 30 fixed to the cover part 12 via the gasket 40, leading to separation of a portion or all of the external terminal 30 from the cover part 12. As a result, a gap (a release path of the internal pressure) develops between the cover part 12 and the external terminal 30, allowing for release of the internal pressure therethrough.

As described above, the cover part 12 is welded to the container part 11, whereas the external terminal 30 is thermally welded to the cover part 12 via the gasket 40. The fixation strength of the external terminal 30 to the cover part 12 is thus lower than the fixation strength (a welding strength) of the cover part 12 to the container part 11. In this case, if the internal pressure of the outer package can 10 excessively increases upon heat generation of the battery device 20, the external terminal 30 is separated from the cover part 12 through the use of thermal deformation of the gasket 40 before the cover part 12 is separated from the container part 11 through the use of an increase in the internal pressure. The external terminal 30 thus operates as the release valve before the outer package can 10 ruptures. A rupture of the outer package can 10 is thereby prevented.

Although not particularly limited, a thermal conductivity (W/m·K) of the external terminal 30 is preferably higher than the thermal conductivity (W/m·K) of the gasket 40, in particular. A reason for this is that this makes it easier for heat generated at the battery device 20 to be transferred to the gasket 40 via the external terminal 30, thus making it easier for the external terminal 30 to operate as the heat-actuated open/close valve.

The gasket 40 is an insulating member that is so disposed between the external terminal 30 and the outer package can 10 as not to cover the through hole 10K, as illustrated in FIG. 1. More specifically, the gasket 40 is disposed between the external terminal 30 and the cover part 12.

The gasket 40 includes any one or more of polymer compounds having an insulating property and a hot melt property. The external terminal 30 is thus thermally welded to the cover part 12 via the gasket 40.

A temperature of deflection under load of the gasket 40, that is, a temperature of deflection under load of the polymer compound as a material included in the gasket 40, is a temperature corresponding to a heat generation temperature of the battery device 20 described above, and more specifically, is within a range from 60° C. to 150° C. both inclusive. A reason for this is that such a range allows the gasket 40 to be thermally deformable and thus allows the external terminal 30 to be operable as the heat-actuated release valve. More specifically, in normal times, it becomes easier for the external terminal 30 to be fixed to the cover part 12 via the gasket 40, and upon the occurrence of an abnormal condition, it becomes easier for the external terminal 30 to be separated from the cover part 12 through the use of the thermal deformation of the gasket 40.

Here, the method of measuring the temperature of deflection under load is in accordance with JIS K7191-2, as described above. To determine the temperature of deflection under load of the gasket 40, the secondary battery may be disassembled to collect the gasket 40 and the gasket 40 may be analyzed, i.e., subjected to measurement of the temperature of deflection under load. Alternatively, physical properties (including a material, a molecular weight, and crystallinity) of the gasket 40 may be examined and thereafter a material (a polymer compound) having physical properties similar to those of the gasket 40 may be prepared separately to thereby analyze the polymer compound.

In this case, although not particularly limited, a melting point of the gasket 40 is preferably within a range from 130° C. to 250° C. both inclusive, in particular. A reason for this is that in such a case, it becomes easier for the external terminal 30 to be separated from the cover part 12 through the use of melting of the gasket 40, and it thus becomes easier for the external terminal 30 to operate as the heat-actuated release valve.

Specific examples of the polymer compound as the material included in the gasket 40 are not particularly limited as long as the above-described condition related to the temperature of deflection under load is satisfied. By way of example, however, the polymer compound may be polypropylene or polyethylene.

Here, as described above, the gasket 40 does not cover the through hole 10K. The gasket 40 is thus ring-shaped in a plan view, having a through hole at a location corresponding to the through hole 10K. Note that the plan shape of the gasket 40 is not particularly limited, and may be changed as desired.

A range of placement of the gasket 40 is not particularly limited, and may be chosen as desired. Here, the gasket 40 is disposed between a top surface of the cover part 12 and a bottom surface of the external terminal 30 inside the recessed part 12U. Note that the range of placement of the gasket 40 may be extended to an outer side of a space between the top surface of the cover part 12 and the bottom surface of the external terminal 30.

The positive electrode lead 51 is a coupling wiring line for the positive electrode 21, being contained inside the outer package can 10 and coupling the positive electrode 21 to the external terminal 30, as illustrated in FIG. 1. The positive electrode lead 51 is coupled to the positive electrode current collector 21A, and is coupled to the external terminal 30 via the through hole 10K.

Here, the secondary battery includes one positive electrode lead 51. Note that the secondary battery may include two or more positive electrode leads 51. A reason for this is that an increase in the number of the positive electrode leads 51 results in a decrease in electric resistance of the battery device 20.

Details of a material included in the positive electrode lead 51 are similar to the details of the material included in the positive electrode current collector 21A. Note that the material included in the positive electrode lead 51 and the material included in the positive electrode current collector 21A may be the same as or different from each other.

Note that the positive electrode lead 51 is physically separate from the positive electrode current collector 21A and is thus provided separately from the positive electrode current collector 21A. Alternatively, the positive electrode lead 51 may be physically continuous with the positive electrode current collector 21A and may thus be provided integrally with the positive electrode current collector 21A.

The negative electrode lead 52 is a coupling wiring line for the negative electrode 22, being contained inside the outer package can 10 and coupling the negative electrode 22 to the outer package can 10, as illustrated in FIG. 1. The negative electrode lead 52 is coupled to the negative electrode current collector 22A, and is coupled to the container part 11.

Here, the secondary battery includes one negative electrode lead 52. Note that the secondary battery may include two or more negative electrode leads 52. A reason for this is that an increase in the number of the negative electrode leads 52 results in a decrease in electric resistance of the battery device 20.

Details of a material included in the negative electrode lead 52 are similar to the details of the material included in the negative electrode current collector 22A. Note that the material included in the negative electrode lead 52 and the material included in the negative electrode current collector 22A may be the same as or different from each other.

Note that the negative electrode lead 52 is physically separate from the negative electrode current collector 22A and is thus provided separately from the negative electrode current collector 22A. Alternatively, the negative electrode lead 52 may be physically continuous with the negative electrode current collector 22A and may thus be provided integrally with the negative electrode current collector 22A.

As illustrated in FIG. 1, the insulating plates 61 and 62 are disposed to allow the battery device 20 to be interposed therebetween in a height direction, and are thus opposed to each other with the battery device 20 interposed therebetween. The insulating plate 61 is disposed between the cover part 12 and the battery device 20. The insulating plates 61 and 62 each include any one or more of insulating materials including, without limitation, polyimide.

Note that the insulating plate 61 preferably has a through hole 61K located to overlap a portion or all of the winding center space 20K. A reason for this is that, as will be described later, when the electrolytic solution is injected into the container part 11 containing a wound body in a process of manufacturing the secondary battery, a portion of the electrolytic solution is supplied into the winding center space 20K, which makes it easier for the wound body to be impregnated with the electrolytic solution. FIG. 1 illustrates a case where the through hole 61K has an inner diameter greater than an inner diameter of the winding center space 20K and where the through hole 61K overlaps all of the winding center space 20K.

As illustrated in FIG. 1, the sealant 70 is a member that protects the positive electrode lead 51, and has a tube-shaped structure to cover a periphery of the positive electrode lead 51. The sealant 70 includes an insulating material such as a polymer compound. Examples of the polymer compound include polyimide. The positive electrode lead 51 is thus insulated from each of the cover part 12 and the negative electrode 22 via the sealant 70.

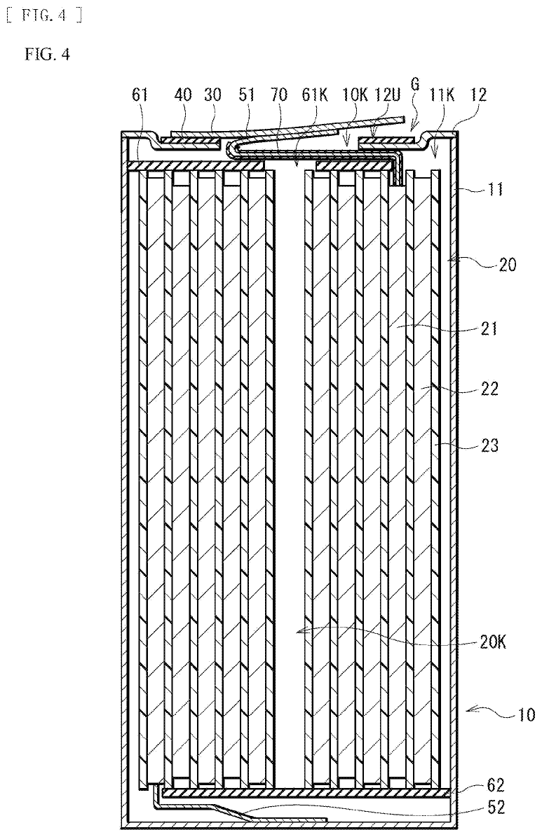

To describe dimensional conditions of the secondary battery, FIG. 3 enlarges a portion of the sectional configuration of the secondary battery illustrated in FIG. 1. Note that FIG. 3 illustrates the cover part 12, the external terminal 30, and the gasket 40 together with a portion of the container part 11.

In the secondary battery, in order for the external terminal 30 to operate as the heat-actuated open/close valve, predetermined conditions (dimensional conditions) are satisfied in relation to dimensions (thicknesses) of a series of components, as illustrated in FIG. 3. In the following, the dimensional conditions related to a thickness T1 of the container part 11, a thickness T2 of the cover part 12, a thickness T3 of the external terminal 30, and a thickness T4 of the gasket 40 will be described.

Specifically, the thickness T2 of the cover part 12 is smaller than the thickness T1 of the container part 11. A reason for this is that this makes it easier for the external terminal 30 to operate as the heat-actuated open/close valve while ensuring shape stability of the outer package can 10.

In more detail, owing to the thickness T1 being greater than the thickness T2, the container part 11 has rigidity greater than that of the cover part 12. In this case, the container part 11 constituting most part of the outer package can 10 is sufficiently great in rigidity, which improves physical strength of the entire outer package can 10. This helps to prevent the outer package can from being easily deformed due to pressures inside and outside the outer package can 10, and thus improves the shape stability of the outer package can 10.

Moreover, owing to the thickness T2 being smaller than the thickness T1, the cover part 12 is thinner than the container part 11. In this case, it becomes easier for heat generated at the battery device 20 to be transferred to the gasket 40 via the cover part 12, and accordingly, it becomes easier for the gasket 40 to be thermally deformed. This makes it easier for the external terminal to be separated from the cover part 12, thus making it easier for the external terminal 30 to operate as the heat-actuated release valve.

Respective values of the thicknesses T1 and T2 are not particularly limited as long as the thickness T2 is smaller than the thickness T1. The thicknesses T1 and T2 are each preferably mm or more, in particular. A reason for this is that such a thickness range allows heat conduction efficiency of each of the container part 11 and the cover part 12 to be sufficiently high while ensuring rigidity of each of the container part 11 and the cover part 12. When the thicknesses T1 and T2 are each less than 50 mm, heat is easily transferred from each of the container part 11 and the cover part 12 to the gasket 40; however, heat is easily dissipated from each of the container part 11 and the cover part 12, resulting in a decrease in transfer efficiency of the heat.

Note that the thickness T4 of the gasket 40 is not particularly limited. The thickness T4 of the gasket 40 is preferably smaller than the thickness T2 of the cover part 12, in particular. A reason for this is that this makes it easier for heat generated at the battery device 20 to be transferred to the gasket 40 via the cover part 12, thus making it easier for the external terminal 30 to be separated from the cover part 12. Further, the thickness T4 of the gasket 40 is preferably smaller than the thickness T3 of the external terminal 30. A reason for this is that this makes it easier for heat generated at the battery device 20 to be transferred to the gasket 40 via the external terminal 30, thus making it easier for the external terminal 30 to be separated from the cover part 12.

Although not particularly limited, the thickness T3 of the external terminal 30 is preferably greater than the thickness T2 of the cover part 12, in particular. A reason for this is that this ensures rigidity of the external terminal 30 and thus suppresses excessive deformation of the external terminal 30. As a result, the external terminal 30 is prevented from being unintentionally actuated as the heat-actuated open/close valve, that is, from being unnecessarily actuated as the heat-actuated open/close valve at times other than when necessary.

Note that the thickness T1 is an average value of thicknesses measured at five locations separated from each other. The same applies to each of the thicknesses T2 to T4.

To describe operations of the secondary battery, FIG. 4 illustrates a sectional configuration corresponding to FIG. 1. In the following, description is given first of an operation at the time of charging and discharging, and thereafter of an operation at the time of occurrence of an abnormal condition.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon the charging and the discharging, lithium is inserted and extracted in an ionic state.

Upon heat generation of the battery device 20, a gas is generated due to, for example, a decomposition reaction of the electrolytic solution, and the internal pressure of the outer package can 10 thus increases. In such a case, the external terminal 30 operates as the heat-actuated release valve, allowing for release of the internal pressure before the outer package can 10 ruptures.

Specifically, when the battery device 20 generates heat, the heat generated at the battery device 20 heats the gasket 40, thus causing the gasket 40 to be thermally deformed. In this case, as illustrated in FIG. 4, the external terminal 30 is separated from the cover part 12 partially or entirely, and as a result, a gap G develops between the cover part 12 and the external terminal 30. FIG. 4 illustrates a case where the external terminal 30 is partially separated from the cover part 12. The gap G is thus used to release the internal pressure to thereby prevent a rupture of the outer package can 10.

In this case, in particular, the external terminal 30 is actuated as the open/close valve in response to a sufficient increase in the internal temperature of the outer package can 10, even without an excessive increase in the internal pressure of the outer package can 10. This allows for release of the internal pressure before the outer package can 10 ruptures, and thus effectively prevents a rupture of the outer package can 10.

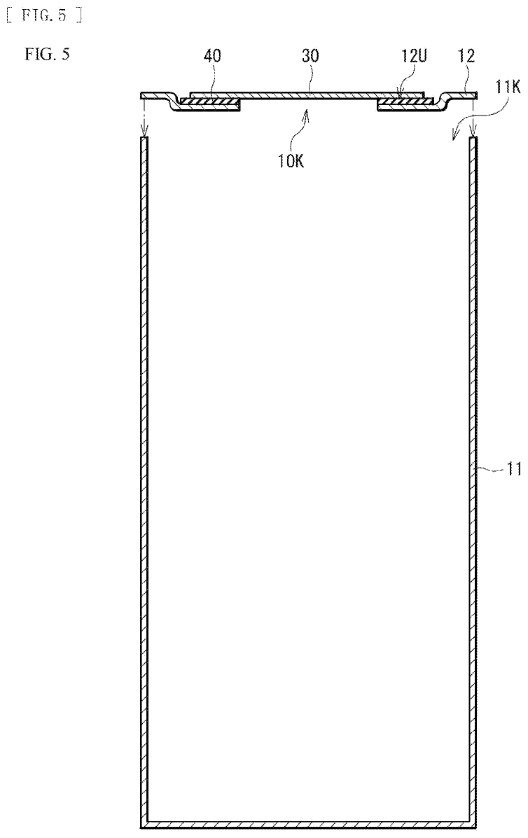

FIG. 5 illustrates a sectional configuration corresponding to FIG. 1 to describe a method of manufacturing the secondary battery. FIG. 5 illustrates a state where the container part 11 and the cover part 12 are separated from each other. In the following description, where appropriate, FIGS. 1 to 3 described already will be referred to in conjunction with FIG. 5.

In a case of manufacturing the secondary battery, according to an example procedure described below, the positive electrode 21 and the negative electrode 22 are fabricated and the electrolytic solution is prepared, following which the secondary battery is assembled using the positive electrode 21, the negative electrode 22, and the electrolytic solution, and the secondary battery after being assembled is subjected to a stabilization process.

Here, as illustrated in FIG. 5, the container part 11 and the cover part 12 that are physically separate from each other are used to form the outer package can 10. As described above, the container part 11 has the opening 11K. Further, as described above, the cover part 12 has the recessed part 12U, with the external terminal 30 thermally welded to the cover part 12 via the gasket 40 in advance.

First, a positive electrode mixture that is a mixture of the positive electrode active material, the positive electrode binder, and the positive electrode conductor is put into a solvent to thereby prepare a positive electrode mixture slurry in a paste form. The solvent may be an aqueous solvent or an organic solvent. The details of the solvent described here apply also to the description below. Thereafter, the positive electrode mixture slurry is applied on the two opposed surfaces of the positive electrode current collector 21A to thereby form the positive electrode active material layers 21B. Lastly, the positive electrode active material layers 21B are compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

First, a negative electrode mixture that is a mixture of the negative electrode active material, the negative electrode binder, and the negative electrode conductor is put into a solvent to thereby prepare a negative electrode mixture slurry in a paste form. Thereafter, the negative electrode mixture slurry is applied on the two opposed surfaces of the negative electrode current collector 22A to thereby form the negative electrode active material layers 22B. Lastly, the negative electrode active material layers 22B are compression-molded by means of, for example, a roll pressing machine. Details of the compression molding of the negative electrode active material layers 22B are similar to the details of the compression molding of the positive electrode active material layers 21B. In this manner, the negative electrode active material layers 22B are formed on the respective two opposed surfaces of the negative electrode current collector 22A. Thus, the negative electrode 22 is fabricated.

The electrolyte salt is put into the solvent. The electrolyte salt is thereby dispersed or dissolved in the solvent. Thus, the electrolytic solution is prepared.

First, the positive electrode lead 51 whose periphery is covered in part by the sealant 70 is coupled to the positive electrode current collector 21A of the positive electrode 21 by means of, for example, a welding method. Further, the negative electrode lead 52 is coupled to the negative electrode current collector 22A of the negative electrode 22 by means of, for example, a welding method. The welding method includes one or more of methods including, without limitation, a resistance welding method and a laser welding method. The details of the welding method described here apply also to the description below.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate the wound body (not illustrated) having the winding center space 20K. The wound body has a configuration similar to the configuration of the battery device 20 except that the positive electrode 21, the negative electrode 22, and the separator 23 are each unimpregnated with the electrolytic solution.

Thereafter, the insulating plates 61 and 62 are disposed to be opposed to each other with the wound body interposed therebetween, following which the insulating plates 61 and 62 are placed together with the wound body into the container part 11 through the opening 11K. In this case, the negative electrode lead 52 is coupled to the container part 11 by means of, for example, a welding method.

Thereafter, the electrolytic solution is injected into the container part 11 through the opening 11K. The wound body (including the positive electrode 21, the negative electrode 22, and the separator 23) is thereby impregnated with the electrolytic solution. Thus, the battery device 20 is fabricated. In this case, a portion of the electrolytic solution is supplied into the winding center space 20K, and the wound body is thus impregnated with the electrolytic solution from the inside of the winding center space 20K.

Thereafter, the opening 11K is closed with use of the cover part 12 to which the external terminal 30 is thermally welded via the gasket 40, following which the cover part 12 is joined to the container part 11. Here, the cover part 12 is welded to the container part 11 by means of a welding method. In this case, the positive electrode lead 51 is coupled to the external terminal 30 via the through hole 10K by means of, for example, a welding method.

Note that in a case of thermally welding the external terminal 30 to the cover part 12 with use of the gasket 40, the gasket 40 is interposed between the cover part 12 and the external terminal 30, following which the gasket 40 is heated. A heating temperature may be chosen as desired, in accordance with conditions including, without limitation, the material included in the gasket 40.

The container part 11 and the cover part 12 are thus welded to each other. In this manner, the outer package can 10 is formed, and the battery device 20 and other components are placed into the outer package can 10. The secondary battery is thus assembled.

### [Stabilization of Secondary Battery]

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of each of the positive electrode 21 and the negative electrode 22 in the battery device 20. This brings the secondary battery into an electrochemically stable state.

As a result, the battery device 20 and other components are sealed in the outer package can 10. The secondary battery is thus completed.

According to the secondary battery, the following action and effects are achieved according to an embodiment.

In the secondary battery of an embodiment, the battery device 20 is contained inside the outer package can 10 having the through hole 10K. The external terminal 30 disposed on the outer side of the outer package can 10 covers the through hole 10K. The gasket 40 disposed between the external terminal 30 and the outer package can 10 does not cover the through hole 10K. The outer package can 10 includes the container part 11 and the cover part 12 joined to each other. The gasket 40 has a temperature of deflection under load in the range from 60° C. to 150° C. both inclusive. The thickness T2 of the cover part 12 is smaller than the thickness T1 of the container part 11. Accordingly, for a reason described below, it is possible to achieve superior safety.

In the following, comparisons are made between the secondary battery of an embodiment and secondary batteries of two comparative examples, and differences between the secondary batteries in action and effects are described.

FIG. 6 illustrates a sectional configuration of a secondary battery of a first comparative example, and corresponds to FIG. 1. As illustrated in FIG. 6, the secondary battery of the first comparative example has a configuration similar to the configuration of the secondary battery of an embodiment illustrated in FIG. 1, except for the following points.

Specifically, the secondary battery of the first comparative example includes an outer package can 80 that is a crimped can formed by means of the crimping processing, in contrast to the secondary battery of an embodiment including the outer package can 10 that is a welded can, i.e., a crimpless can, formed by means of a welding method. The outer package can 80 includes a container part 81 and a cover part 82. The secondary battery of the first comparative example further includes the safety valve mechanism 91, a thermosensitive resistive device (a PTC device) 92, and a gasket 93.

The container part 81 has a configuration similar to the configuration of the container part 11. Specifically, the container part 81 has a hollow cylindrical three-dimensional shape with an opening 81K. The container part 81 includes a material similar to the material of the container part 11.

The cover part 82, the safety valve mechanism 91, and the PTC device 92 are crimped, via the gasket 93, to one end part (an open end part) of the container part 81 in which the opening 81K is provided. The opening 81K is thus sealed by the cover part 82. The cover part 82 includes a material similar to the material of the container part 81. The safety valve mechanism 91 and the PTC device 92 are each provided on an inner side of the cover part 82, and the safety valve mechanism 91 is electrically coupled to the cover part 82 via the PTC device 92. The gasket 93 includes an insulating material such as polypropylene.

In the safety valve mechanism 91, upon an increase in internal pressure of the outer package can 80, a disk plate 91A inverts to release the internal pressure and to cut off the electrical coupling between the battery device 20 and the cover part 12. The safety valve mechanism 91 thus serves as the pressure-actuated release valve. To prevent abnormal heat generation resulting from a large current, the PTC device 92 increases in electrical resistance with a rise in temperature.

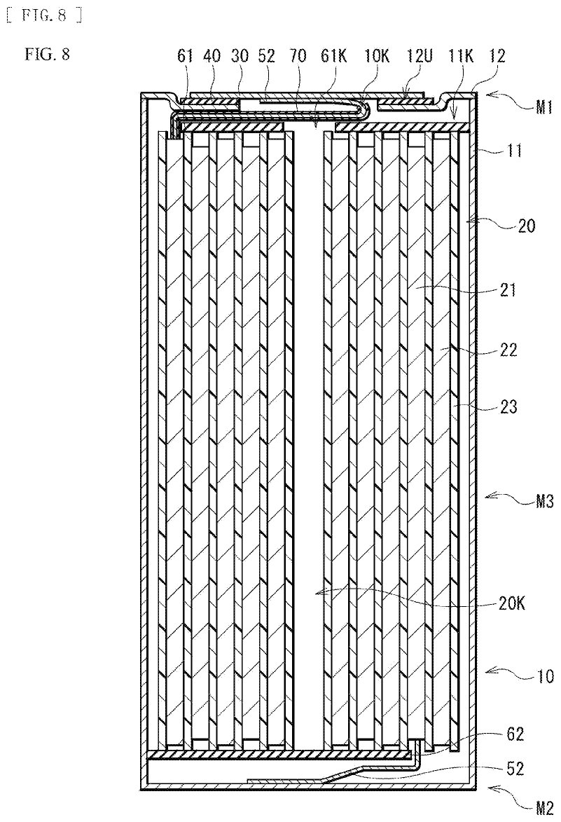

FIG. 7 illustrates a sectional configuration of a secondary battery of a second comparative example, and corresponds to FIG. 1. The secondary battery of the second comparative example has a configuration similar to the configuration of the secondary battery of an embodiment illustrated in FIG. 1, except for including a gasket 140 instead of the gasket 40. The gasket 140 includes a glass having a high temperature of deflection under load that exceeds 200° C., and the external terminal 30 is thermally welded to the cover part 12 via the gasket 140.

As described above, the secondary battery of the first comparative example includes the safety valve mechanism 91 that serves as the pressure-actuated release valve. The safety valve mechanism 91 is actuated in response to an increase in the internal pressure. Depending on an internal condition of the outer package can 80, however, this can result in deterioration of safety of the secondary battery.

In more detail, if the battery device 20 rapidly generates heat due to, for example, what is called a thermal runaway, an increase rate of the internal temperature of the outer package can becomes higher than an increase rate of the internal pressure of the outer package can 80. In such a case, the internal temperature of the outer package can 80 excessively increases before the internal pressure of the outer package can 80 reaches a pressure at which the safety valve mechanism 91 is drivable. As a result, the outer package can 80 becomes markedly high in temperature at a point in time when the safety valve mechanism 91 is actuated.

Thus, according to the secondary battery of the first comparative example, the temperature of the secondary battery becomes high upon heat generation of the battery device 20. This makes it difficult to achieve superior safety.

Note that if the positive electrode 21 includes the lithium compound (the phosphoric acid compound) having the olivine crystal structure as the positive electrode active material, it becomes less easy for a gas to be generated inside the outer package can 80 as described above, and accordingly, it basically becomes less easy for the internal pressure of the outer package can 10 to increase. In such a case, even if the secondary battery includes the safety valve mechanism 91, the secondary battery easily becomes markedly high in temperature before the safety valve mechanism 91 is actuated. This results in significant deterioration of safety.

In the secondary battery of the second comparative example, the external terminal 30 is thermally welded to the cover part 12 via the gasket 140. It thus seems that the external terminal 30 is operable as a heat-actuated release valve.

However, the gasket 140 includes the glass having a high temperature of deflection under load, and thus a temperature at which the gasket 140 is thermally deformable is higher than the heat generation temperature of the battery device 20. In such a case, even if the battery device 20 generates heat, the gasket 140 is unable to reach the temperature at which the gasket 140 is thermally deformable, which makes the external terminal 30 unable to be separated from the cover part 12. The external terminal 30 is thus substantially unable to operate as the heat-actuated open/close valve. Accordingly, an excessive increase in the internal pressure of the outer package can 10 results in a rupture of the outer package can 10.

Thus, in the secondary battery of the second comparative example, the outer package can 10 is prone to rupture upon heat generation of the battery device 20. This makes it difficult to achieve superior safety.

In contrast, in the secondary battery of an embodiment, the external terminal 30 is thermally welded to the cover part 12 via the gasket 40, and the external terminal 30 thus serves as the heat-actuated release valve.

In more detail, the gasket 40 has a suitably low temperature of deflection under load, i.e., in the range from 60° C. to 150° C. both inclusive, and the temperature at which the gasket 40 is thermally deformable is substantially the same as the heat generation temperature of the battery device 20. In this case, upon heat generation of the battery device 20, the gasket 40 reaches the temperature at which the gasket 40 is thermally deformable, and as a result, the external terminal 30 is separated from the cover part 12. The external terminal 30 is thus substantially able to operate as the heat-actuated open/close valve, allowing for release of the internal pressure before the outer package can 10 ruptures. Further, the outer package can 10 is internally cooled in association with the release of the internal pressure. This helps to prevent the internal temperature of the outer package can 10 from excessively increasing easily.

Moreover, the thickness T2 of the cover part 12 is smaller than the thickness T1 of the container part 11. This makes it easier for heat generated at the battery device 20 to be transferred to the gasket 40 via the cover part 12, and allows the container part 11 constituting most part of the outer package can 10 to be greater in rigidity than the cover part 12, i.e., a portion of the outer package can 10. Accordingly, the outer package can 10 is prevented from being broken easily upon an increase in the internal pressure, and it becomes further easier for the external terminal 30 to operate as the heat-actuated open/close valve.

Thus, according to the secondary battery of an embodiment, upon heat generation of the battery device 20, it is less easy for the outer package can to become high in temperature, and the outer package can 10 is prevented from rupturing easily. Accordingly, it is possible to achieve superior safety.

In the secondary battery of an embodiment, the thickness T4 of the gasket 40 may be smaller than the thickness T2 of the cover part 12, in particular. This makes it easier for heat generated at the battery device 20 to be transferred to the gasket 40 via the cover part 12. The gasket 40 is thus thermally deformable more easily. Accordingly, it is possible to achieve higher effects.

Further, the thickness T4 of the gasket 40 may be smaller than the thickness T3 of the external terminal 30. This makes it easier for heat generated at the battery device 20 to be transferred to the gasket 40 via the external terminal 30. The gasket 40 is thus thermally deformable more easily. Accordingly, it is possible to achieve higher effects.

Further, the thickness T3 of the external terminal 30 may be greater than the thickness T2 of the cover part 12. This suppresses an excessive deformation of the external terminal 30. The external terminal 30 serving as the heat-actuated open/close valve is thus prevented from being unintentionally actuated, that is, from being erroneously actuated. Accordingly, it is possible to achieve higher effects.

Further, the gasket 40 may have a melting point in the range from 130° C. to 250° C. both inclusive. This makes it easier to cause the external terminal 30 to operate as the heat-actuated release valve through the use of melting of the gasket 40. Accordingly, it is possible to achieve higher effects.

Further, the thermal conductivity of the cover part 12 may be greater than the thermal conductivity of the gasket 40. This makes it easier for heat generated at the battery device 20 to be transferred to the gasket 40 via the cover part 12. The gasket 40 is thus thermally deformable more easily. Accordingly, it is possible to achieve higher effects.

Further, the thermal conductivity of the external terminal 30 may be greater than the thermal conductivity of the gasket 40. This makes it easier for heat generated at the battery device 20 to be transferred to the gasket 40 via the external terminal 30. The gasket 40 is thus thermally deformable more easily. Accordingly, it is possible to achieve higher effects.

Further, the external terminal 30 may include aluminum, an aluminum alloy, or both. This improves the thermal conductivity of the external terminal 30 and increases a gravimetric energy density of the secondary battery. Accordingly, it is possible to achieve higher effects.

Note that the use of the external terminal 30 serving as the heat-actuated release valve effectively suppresses a rupture of the outer package can 10 even if aluminum, an aluminum alloy, or both, which are low in physical strength while being lightweight, are used as the material of the external terminal 30. It is thus possible to achieve improved safety also from this regard.

Further, the positive electrode 21 may be electrically coupled to the external terminal 30, and the negative electrode 22 may be electrically coupled to the outer package can 10. In such a case, the external terminal 30 serves as an external coupling terminal for the positive electrode 21, and the outer package can 10 serves as an external coupling terminal for the negative electrode 22. This allows the secondary battery to be easily couplable to electronic equipment via the outer package can 10 and the external terminal 30, and allows for an increase in energy density per unit volume owing to an increase in device space volume. Accordingly, it is possible to achieve higher effects.

Further, the cover part 12 may include the recessed part 12U, and the external terminal 30 may be disposed inside the recessed part 12U. This allows for an increase in volumetric energy density owing to an increase in device space volume. Accordingly, it is possible to achieve higher effects.

Further, the positive electrode 21 may include a positive electrode active material having the olivine crystal structure. In such a case, even if it is basically less easy for the internal pressure of the outer package can 10 to increase upon heat generation of the battery device 20, the internal pressure is sufficiently releasable through the use of the external terminal 30 serving as the heat-actuated open/close valve. Accordingly, it is possible to achieve higher effects.

Further, the secondary battery may include a lithium-ion secondary battery. In such a case, a sufficient battery capacity is stably obtainable through the use of insertion and extraction of lithium. Accordingly, it is possible to achieve higher effects.

The configuration of the secondary battery described above is appropriately modifiable, including as described below according to an embodiment. Note that any two or more of the following series of modifications may be combined with each other.

In FIG. 1, the positive electrode 21 is coupled to the external terminal 30 via the positive electrode lead 51, and the negative electrode 22 is coupled to the container part 11 via the negative electrode lead 52. Thus, the external terminal 30 serves as the external coupling terminal for the positive electrode 21, and the outer package can 10 serves as the external coupling terminal for the negative electrode 22.

However, as illustrated in FIG. 8 corresponding to FIG. 1, the positive electrode 21 may be coupled to the container part 11 via the positive electrode lead 51, and the negative electrode 22 may be coupled to the external terminal 30 via the negative electrode lead 52. Thus, the outer package can 10 may serve as the external coupling terminal for the positive electrode 21, and the external terminal 30 may serve as the external coupling terminal for the negative electrode 22.

In this case, to serve as the external coupling terminal for the negative electrode 22, the external terminal 30 includes any one or more of electrically conductive materials including, without limitation, a metal material and an alloy material. Examples of the electrically conductive materials include iron, copper, nickel, stainless steel, an iron alloy, a copper alloy, and a nickel alloy. To serve as the external coupling terminal for the positive electrode 21, the outer package can 10 (including the container part 11 and the cover part 12) includes any one or more of electrically conductive materials including, without limitation, a metal material and an alloy material. Examples of the electrically conductive materials include aluminum, an aluminum alloy, and stainless steel.

In this case also, the secondary battery is couplable to electronic equipment via the external terminal 30, i.e., the external coupling terminal for the negative electrode 22, and the outer package can 10, i.e., the external coupling terminal for the positive electrode 21. Accordingly, it is possible to achieve effects similar to the effects achievable in the case illustrated in FIG. 1.

In this case, in particular, owing to the outer package can 10 including aluminum, an aluminum alloy, or both, the thermal conductivity of the outer package can 10 improves and the gravimetric energy density of the secondary battery increases markedly. Accordingly, it is possible to achieve higher effects.

Note that in a case of using a crimped can (the outer package can 80) formed by means of the crimping processing, it is difficult to use aluminum, an aluminum alloy, or both as the material of the outer package can 80. A reason for this is that this results in insufficient physical strength of the container part 81 and thus makes it difficult to fix the cover part 82 to the container part 81 by means of the crimping processing.

In contrast, in a case of using a welded can (the outer package can 10) formed by means of welding processing, aluminum, an aluminum alloy, or both are usable as the material of the outer package can 10. A reason for this is that in such a case, the physical strength of the container part 11 does not become a problem and the cover part 82 is fixed (welded) to the container part 81 without the crimping processing. Accordingly, as described above, a marked increase in gravimetric energy density is achievable by using aluminum, an aluminum alloy, or both as the material of the outer package can 10.

In FIG. 1, the positive electrode 21 and the negative electrode 22 are so wound as to allow the negative electrode 22 to be disposed in the outermost wind, and the exposed part 22AY that is an end part of the negative electrode current collector 22A on the outer side of the winding is separated from the outer package can 10.

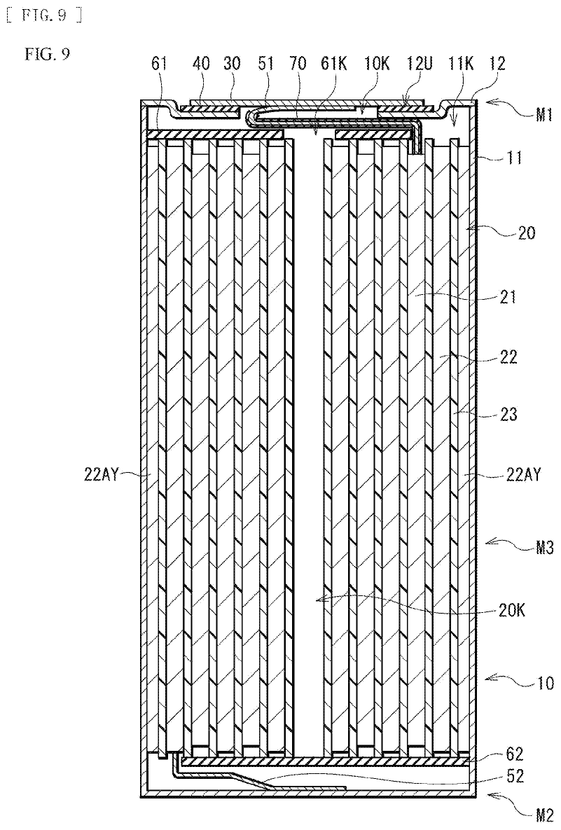

However, as illustrated in FIG. 9 corresponding to FIG. 1, the exposed part 22AY may be coupled to the container part 11 to allow the negative electrode current collector 22A to be electrically coupled to the outer package can 10 directly. A coupling area between the exposed part 22AY and the container part 11 may be chosen as desired.

In such a case also, the external terminal 30 operates as the heat-actuated open/close valve. Accordingly, it is possible to achieve effects similar to the effects achievable in the case illustrated in FIG. 1.

In this case, in particular, it becomes easier for heat generated at the battery device 20 to be transferred to the outer package can 10 via the exposed part 22AY, which makes it easier for the heat to be transferred to the gasket 40 via the cover part 12. This makes it easier for the external terminal 30 to operate as the heat-actuated open/close valve. Accordingly, it is possible to achieve higher effects.

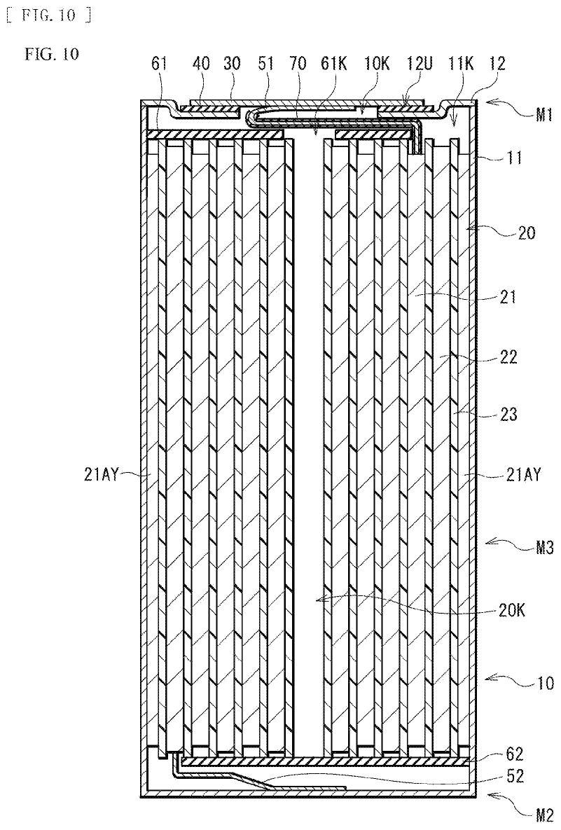

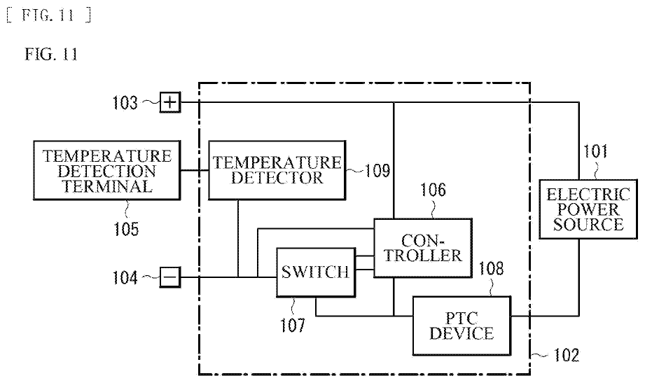

As illustrated in FIG. 10 corresponding to FIG. 1, the positive electrode 21 and the negative electrode 22 may be so wound as to allow the positive electrode 21 to be disposed in the outermost wind, and the exposed part 21AY that is an end part of the positive electrode current collector 21A on the outer side of the winding may be coupled to the container part 11 to allow the positive electrode current collector 21A to be electrically coupled to the outer package can 10 directly. A coupling area between the exposed part 21AY and the container part 11 may be chosen as desired.

Note that in a case where the exposed part 21AY is coupled to the container part 11, the negative electrode current collector 22A may entirely be covered with the negative electrode active material layer 22B, and the negative electrode current collector 22A may thus include neither of the exposed parts 22AX and 22AY.

In such a case also, the external terminal 30 serves as the heat-actuated open/close valve. Accordingly, it is possible to achieve effects similar to the effects achievable in the case illustrated in FIG. 1.

In this case, in particular, it becomes easier for heat generated at the battery device 20 to be transferred to the outer package can 10 via the exposed part 21AY, which makes it easier for the heat to be transferred to the gasket 40 via the cover part 12. This makes it easier for the external terminal 30 to operate as the heat-actuated open/close valve. Accordingly, it is possible to achieve higher effects.

In FIG. 1, the ratio D/H is less than 1, and the secondary battery thus has a battery structure of the cylindrical type.

However, although not specifically illustrated here, the ratio D/H may be greater than 1, and the secondary battery may thus have a battery structure of a coin type or a button type. The secondary battery of the coin type has a configuration similar to the configuration of the secondary battery of the cylindrical type, except for being different in the ratio D/H and thus having a flat and columnar three-dimensional shape.

Dimensions of the secondary battery of the coin type are not particularly limited as long as the ratio D/H is greater than 1. By way of example, the outer diameter D is in a range from 3 mm to 30 mm both inclusive, and the height H is in a range from 0.5 mm to 70 mm both inclusive. Although an upper limit of the ratio D/H is not particularly limited, the ratio D/H is preferably 25 or less.

The secondary battery of the coin type also makes it possible to achieve effects similar to the effects achievable in relation to the secondary battery of the cylindrical type.

The separator 23 that is a porous film is used. However, although not specifically illustrated here, a separator of a stacked type that includes a polymer compound layer may be used instead of the separator 23.

Specifically, the separator of the stacked type includes a porous film having two opposed surfaces, and the polymer compound layer provided on one of or each of the two opposed surfaces of the porous film. A reason for this is that this improves adherence of the separator to each of the positive electrode 21 and the negative electrode 22, thus suppressing winding displacement of the battery device 20. Accordingly, the secondary battery is prevented from swelling easily even if the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation of the secondary battery, thus improving safety or heat resistance of the secondary battery. The insulating particles are inorganic particles, resin particles, or both. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, instead of applying the precursor solution on the porous film, the porous film may be immersed in the precursor solution. In addition, the insulating particles may be included in the precursor solution.

In the case where the separator of the stacked type is used also, lithium ions are movable between the positive electrode 21 and the negative electrode 22, and similar effects are therefore obtainable. In this case, in particular, the secondary battery improves in safety, as described above. Accordingly, it is possible to achieve higher effects.

The electrolytic solution that is a liquid electrolyte is used. However, although not specifically illustrated here, an electrolyte layer that is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one of or each of both sides of the positive electrode 21 and on one of or each of both sides of the negative electrode 22.

In the case where the electrolyte layer is used also, lithium ions are movable between the positive electrode 21 and the negative electrode 22 via the electrolyte layer, and similar effects are therefore obtainable. In this case, in particular, leakage of the electrolytic solution is prevented, as described above. Accordingly, it is possible to achieve higher effects.

In FIG. 1, the secondary battery includes the battery device 20 of a wound type, i.e., the wound electrode body. However, although not specifically illustrated here, the secondary battery may include a battery device of a stacked type, i.e., a stacked electrode body.

The battery device of the stacked type has a configuration similar to the configuration of the battery device 20 of the wound type, except for the following.

The battery device of the stacked type includes a positive electrode, a negative electrode, and a separator. The positive electrode and the negative electrode are alternately stacked with the separator interposed therebetween. Accordingly, the battery device of the stacked type includes one or more positive electrodes, one or more negative electrodes, and one or more separators. The positive electrode, the negative electrode, and the separator have respective configurations similar to the respective configurations of the positive electrode 21, the negative electrode 22, and the separator 23.

In a case where the battery device of the stacked type includes a plurality of positive electrodes and a plurality of negative electrodes, a positive electrode lead is coupled to the positive electrode current collector of each of the positive electrodes, and a negative electrode lead is coupled to the negative electrode current collector of each of the negative electrodes. Thus, the secondary battery includes a plurality of positive electrode leads and a plurality of negative electrode leads. The positive electrode leads are joined to each other and are coupled to the external terminal 30. The negative electrode leads are joined to each other and are coupled to the container part 11.

In this case also, charging and discharging are performed with the battery device of the stacked type. Accordingly, it is possible to achieve similar effects.

Applications (application examples) of the secondary battery are not particularly limited. The secondary battery used as a power source serves as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration of the application example described below is merely an example, and is appropriately modifiable.

FIG. 11 illustrates a block configuration of a battery pack. The battery pack described here is a battery pack (what is called a soft pack) including one secondary battery, and is to be mounted on, for example, electronic equipment typified by a smartphone.

As illustrated in FIG. 11, the battery pack includes an electric power source 101 and a circuit board 102. The circuit board 102 is coupled to the electric power source 101, and includes a positive electrode terminal 103, a negative electrode terminal 104, and a temperature detection terminal 105.

The electric power source 101 includes one secondary battery. The secondary battery has a positive electrode lead coupled to the positive electrode terminal 103 and a negative electrode lead coupled to the negative electrode terminal 104. The electric power source 101 is couplable to outside via the positive electrode terminal 103 and the negative electrode terminal 104, and is thus chargeable and dischargeable. The circuit board 102 includes a controller 106, a switch 107, a thermosensitive resistive device (a PTC device) 108, and a temperature detector 109. However, the PTC device 108 may be omitted.

The controller 106 includes, for example, a central processing unit (CPU) and a memory, and controls an overall operation of the battery pack. The controller 106 detects and controls a use state of the electric power source 101 on an as-needed basis.

If a voltage of the electric power source 101 (the secondary battery) reaches an overcharge detection voltage or an overdischarge detection voltage, the controller 106 turns off the switch 107. This prevents a charging current from flowing into a current path of the electric power source 101. The overcharge detection voltage is not particularly limited, and is specifically 4.2 V±0.05 V. The overdischarge detection voltage is not particularly limited, and is specifically 2.4 V±0.1 V.

The switch 107 includes, for example, a charge control switch, a discharge control switch, a charging diode, and a discharging diode. The switch 107 performs switching between coupling and decoupling between the electric power source 101 and external equipment in accordance with an instruction from the controller 106. The switch 107 includes, for example, a metal-oxide-semiconductor field-effect transistor (MOSFET). The charging and discharging currents are detected based on an ON-resistance of the switch 107.

The temperature detector 109 includes a temperature detection device such as a thermistor. The temperature detector 109 measures a temperature of the electric power source 101 using the temperature detection terminal 105, and outputs a result of the temperature measurement to the controller 106. The result of the temperature measurement to be obtained by the temperature detector 109 is used, for example, in a case where the controller 106 performs charge and discharge control upon abnormal heat generation or in a case where the controller 106 performs a correction process upon calculating a remaining capacity.

### EXAMPLES

A description is given of Examples of the present technology according to an embodiment.

### Examples 1 to 11 and Comparative Examples 1 to 5

Secondary batteries were fabricated, following which the secondary batteries were evaluated for performance.

### [Fabrication of Secondary Battery of Cylindrical Type]

The secondary batteries illustrated in FIGS. 1 to 3 (lithium-ion secondary batteries of the cylindrical type) were fabricated in accordance with a procedure described below. The secondary batteries each included the external terminal 30 serving as the heat-actuated release valve.

### (Fabrication of Positive Electrode)

First, 91 parts by mass of the positive electrode active material, 3 parts by mass of the positive electrode binder (polyvinylidene difluoride), and 6 parts by mass of the positive electrode conductor (graphite) were mixed with each other to thereby obtain a positive electrode mixture. As listed in Table 1, used as the positive electrode active materials were LiNi_{0.8}Co_{0.15}Al_{0.05}O₂ (denoted as NCA) and LiCoO₂ (denoted as LCO) as the lithium compounds (the composite oxides) each having the layered rock-salt crystal structure, and LiFePO₄ (denoted as LFP) having the olivine crystal structure. Thereafter, the positive electrode mixture was put into a solvent (N-methyl-2-pyrrolidone, an organic solvent), following which the organic solvent was stirred to thereby prepare a positive electrode mixture slurry in a paste form. Thereafter, the positive electrode mixture slurry was applied on the two opposed surfaces of the positive electrode current collector 21A (a band-shaped aluminum foil having a thickness of 12 μm) by means of a coating apparatus, following which the applied positive electrode mixture slurry was dried to thereby form the positive electrode active material layers 21B. In this case, an application range of the positive electrode mixture slurry was adjusted to provide the positive electrode current collector 21A with the exposed parts 21AX and 21AY. Lastly, the positive electrode active material layers 21B were compression-molded by means of a roll pressing machine. In this manner, the positive electrode 21 was fabricated.

### (Fabrication of Negative Electrode)

First, 95 parts by mass of the negative electrode active material (including graphite as a carbon material and SiO as a metal-based material) and 5 parts by mass of the negative electrode binder (polyvinylidene difluoride) were mixed with each other to thereby obtain a negative electrode mixture. A mixture ratio (a weight ratio) between the carbon material and the metal-based material was set to 95:5. Thereafter, the negative electrode mixture was put into a solvent (N-methyl-2-pyrrolidone, an organic solvent), following which the organic solvent was stirred to thereby prepare a negative electrode mixture slurry in a paste form. Thereafter, the positive electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. In this case, an application range of the negative electrode mixture slurry was adjusted to provide the negative electrode current collector 22A with the exposed parts 22AX and 22AY. Lastly, the negative electrode active material layers 22B were compression-molded by means of a roll pressing machine. In this manner, the negative electrode 22 was fabricated.

### (Preparation of Electrolytic Solution)

The electrolyte salt (LiPF₆) was added to the solvent (ethylene carbonate and diethyl carbonate), following which the solvent was stirred. A mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### (Assembly of Secondary Battery)

First, by means of a resistance welding method, the positive electrode lead 51 (aluminum) was welded to the positive electrode current collector 21A of the positive electrode 21, and the negative electrode lead 52 (aluminum) was welded to the negative electrode current collector 22A of the negative electrode 22.

Thereafter, the positive electrode 21 and the negative electrode 22 were stacked on each other with the separator 23 (polyethylene, 10 μm in thickness) interposed therebetween, following which the stack of the positive electrode 21, the negative electrode 22, and the separator 23 was wound to thereby fabricate the wound body having the winding center space 20K. In this case, the positive electrode 21 and the negative electrode 22 were so wound as to allow the positive electrode 21 or the negative electrode 22 to be disposed in the outermost wind.

Thereafter, the wound body was sandwiched between the insulating plates 61 and 62 (polyimide), following which the insulating plates 61 and 62 were placed together with the wound body into the container part 11 through the opening 11K. The material and the thickness T1 (mm) of the container part 11 were as listed in Table 1. The material of the container part 11 was iron (Fe) having a thermal conductivity of 83.5 W/m·K, aluminum (Al) having a thermal conductivity of 236 W/m·K, or stainless steel (SUS) having a thermal conductivity of 20 W/m·K. More specifically, in a case where the positive electrode 21 and the negative electrode 22 were so wound as to allow the negative electrode 22 to be disposed in the outermost wind, iron was used as the material of the container part 11, and in a case where the positive electrode 21 and the negative electrode 22 were so wound as to allow the positive electrode 21 to be disposed in the outermost wind, aluminum was used as the material of the container part 11.

In this case, the negative electrode lead 52 was welded to the container part 11 by means of a resistance welding method. In the case where the positive electrode 21 and the negative electrode 22 were so wound as to allow the negative electrode 22 to be disposed in the outermost wind, the exposed part 22AY was welded to the container part 11 by means of the resistance welding method. In the case where the positive electrode 21 and the negative electrode 22 were so wound as to allow the positive electrode 21 to be disposed in the outermost wind, the exposed part 21AY was welded to the container part 11 by means of the resistance welding method. Note that in the case where the positive electrode 21 and the negative electrode 22 were so wound as to allow the negative electrode 22 to be disposed in the outermost wind, the welding of the exposed part 22AY to the container part 11 was omitted in some cases as appropriate.

Thereafter, prepared was the cover part 12 with the external terminal 30 thermally welded thereto via the gasket 40. Respective materials of the cover part 12, the external terminal 30, and the gasket 40, the thickness T2 (mm) of the cover part 12, the thickness T3 (mm) of the external terminal 30, and the thickness T4 (mm) of the gasket 40 were as listed in Table 1. The material of the cover part 12 was the same as the material of the container part 11. The material of the external terminal 30 was a cladding material (Al/NiCu) having a thermal conductivity of 127 W/m·K or stainless steel (SUS) having a thermal conductivity of 20 W/m·K. More specifically, in the case where the positive electrode 21 and the negative electrode 22 were so wound as to allow the negative electrode 22 to be disposed in the outermost wind, the cladding material was used as the material of the external terminal 30, and in the case where the positive electrode 21 and the negative electrode 22 were so wound as to allow the positive electrode 21 to be disposed in the outermost wind, stainless steel was used as the material of the container part 11. The cladding material included an Al layer and a NiCu layer that were stacked in this order from a side closer to the cover part 12 and that were roll-bonded to each other. The material of the gasket 40 was polypropylene (PP) having a temperature of deflection under load (at 0.45 MPa) in the range from 60° C. to 150° C. both inclusive, a melting point of 160° C., and a thermal conductivity of 0.12 W/m·K.

In this case, for comparison, also used was the cover part 12 having a similar configuration except that a silicone resin (having a temperature of deflection under load of 200° C. and a melting point of 300° C.) was used as the material of the gasket 40, as listed in Table 1.

Thereafter, the electrolytic solution was injected into the container part 11 through the opening 11K, following which the cover part 12 was welded to the container part 11 by means of a laser welding method. In this case, the positive electrode lead 51 was welded to the external terminal 30 via the through hole 10K by means of a resistance welding method.

The wound body was thus impregnated with the electrolytic solution. In this manner, the battery device 20 was fabricated, and the cover part 12 was joined to the container part 11 to thereby form the outer package can 10. As a result, the battery device 20 and other components were sealed in the outer package can 10. The secondary battery was thus assembled.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C was a value of a current that caused the battery capacity (a theoretical capacity) to be completely discharged in 10 hours, and 0.05 C was a value of a current that caused the battery capacity to be completely discharged in 20 hours.

As a result, a film was formed on the surface of each of the positive electrode 21 and the negative electrode 22 to electrochemically stabilize the state of the secondary battery. Thus, the secondary battery (having an outer diameter D of 21 mm and a height H of 700 mm) was completed.

### [Fabrication of Secondary Battery of Coin Type]

Secondary batteries (lithium-ion secondary batteries of the coin type) each having an outer diameter D of 16 mm and a height H of 5.4 mm were fabricated in accordance with a procedure similar to the fabrication procedure of the secondary batteries of the cylindrical type described above, except that the ratio D/H was changed.

### [Fabrication of Other Secondary Battery of Cylindrical Type]

For comparison, the secondary batteries illustrated in FIG. 6 (lithium-ion secondary batteries of the cylindrical type) were fabricated in accordance with a procedure described below. The secondary batteries each included the safety valve mechanism 91 serving as the pressure-actuated release valve.

The fabrication procedure of the secondary batteries each including the safety valve mechanism 91 was similar to the fabrication procedure of the secondary batteries each including the external terminal 30, except for the following points. In a case of assembling the secondary battery, the insulating plates 61 and 62 were placed together with the wound body into the container part 81 through the opening 81K, following which the positive electrode lead 51 was welded to the safety valve mechanism 91 and the negative electrode lead 52 was welded to the container part 81. Thereafter, the electrolytic solution was injected into the container part 81 to thereby fabricate the battery device 20, following which the cover part 82, the safety valve mechanism 91, and the PTC device 92 were placed into the container part 81 through the opening 81K. Thereafter, the container part 81 was crimped via the gasket 93. The cover part 82 was thereby fixed to the container part 81. Thus, the outer package can 80 was formed and the battery device 20 and other components were sealed in the outer package can 80.

Respective materials of the container part 81, the cover part 82, and the gasket 93, the thickness T1 (mm) of the container part 81, and the thickness T2 (mm) of the cover part 82 were as listed in Table 1.

Note that a series of items listed in Table 1 represents the following. “Battery structure” represents the type of the secondary battery (the cylindrical type or the coin type). “Type of can” represents the type of the outer package can 10 or 80 (the welded can or the crimped can). “Actuation mode” represents a mode of actuation of the open/close valve. Specifically, “Heat” indicates actuation by heat, and “Pressure” indicates actuation by pressure. “Device coupling” represents coupling between the container part 11 and the battery device 20. Specifically, “Negative collector” indicates that the exposed part 22AY is coupled to the container part 11, and “Positive collector” indicates that the exposed part 21AY is coupled to the container part 11.

As a battery characteristic of the secondary battery, an internal pressure release characteristic, one of indexes for evaluating safety, was examined, and the results presented in Table 1 were obtained.

In a case of evaluating the internal pressure release characteristic, a release state of the internal pressure was examined by performing an overcharge test on the secondary battery while measuring a temperature of a middle part of each of the outer package cans 10 and 80 using a thermocouple.

Specifically, in the overcharge test, the secondary battery was overcharged by performing charging with a constant current of 3C until a voltage reached 18 V. In this case, it was determined whether the release valve was actuated in the secondary battery to make it possible to release the internal pressure of the outer package can 10 or 80, that is, the release state was determined. If it was possible to release the internal pressure, an actuation temperature (° C.) of the open/close valve was examined.

The phrase “the release valve was actuated” means that the secondary battery operated as described below. For the secondary battery including the external terminal 30 serving as the heat-actuated release valve, the phrase “the release valve was actuated” means that the internal pressure was released as a result of separation of the external terminal 30 from the cover part 12 in response to an increase in the internal temperature of the outer package can 10. For the secondary battery including the safety valve mechanism 91 serving as the pressure-actuated release valve, the phrase “the release valve was actuated” means that the internal pressure was released as a result of inversion of the disk plate 91A in response to an increase in the internal pressure of the outer package can 80.

Specific determinations as to the release state were made as described below. A case where the release valve was actuated and as a result, the outer package can 10 neither ruptured nor deformed and the battery device 20 was not released from inside to outside the outer package can 10 was rated “A”. A case where the release valve was actuated and as a result, the outer package can 10 did not rupture and the battery device 20 was not released from inside to outside the outer package can 10, but the outer package can 10 deformed was rated “B”. A case where the release valve was actuated and the battery device 20 was not released from inside to outside the outer package can 10, but the outer package can 10 ruptured was rated “C”. A case where the release valve failed to be actuated and the outer package can 10 deformed although the outer package can did not rupture and the battery device 20 was not released from inside to outside the outer package can 10 was rated “D”. A case where the release valve failed to be actuated and the outer package can 10 ruptured to cause the battery device 20 to be released from inside to outside the outer package can 10 was rated “E”.

TABLE 1

| | | | | Material | | | | | | | | | | |
|---|---|---|---|---|---|---|---|---|---|---|---|---|---|---|
| | | | | Outer | | | | | | | | Positive | | |
| | | | Actu- | pack- | | | | | | | | electrode | Re- | Actuation |
| | Battery | Type of | ation | age | External | | T1 | T2 | T3 | T4 | Device | active | lease | tempera- |
| | structure | can | mode | can | terminal | Gasket | (mm) | (mm) | (mm) | (mm) | coupling | material | state | ture (° C.) |
| Example 1 | Cylindrical | Welded | Heat | Fe | Al/NiCu | PP | 0.2 | 0.15 | 0.3 | 0.04 | Negative | NCA | A | 160 |
| | type | can | | | | | | | | | collector | | | |
| Example 2 | Cylindrical | Welded | Heat | Fe | Al/NiCu | PP | 0.2 | 0.15 | 0.3 | 0.2 | Negative | NCA | A | 165 |
| | type | can | | | | | | | | | collector | | | |
| Example 3 | Cylindrical | Welded | Heat | Fe | Al/NiCu | PP | 0.2 | 0.15 | 0.3 | 0.15 | Negative | NCA | A | 163 |
| | type | can | | | | | | | | | collector | | | |
| Example 4 | Cylindrical | Welded | Heat | Fe | Al/NiCu | PP | 0.2 | 0.15 | 0.15 | 0.04 | Negative | NCA | A | 165 |
| | type | can | | | | | | | | | collector | | | |
| Example 5 | Cylindrical | Welded | Heat | Fe | Al/NiCu | PP | 0.2 | 0.15 | 0.15 | 0.15 | Negative | NCA | A | 170 |
| | type | can | | | | | | | | | collector | | | |
| Example 6 | Cylindrical | Welded | Heat | Fe | Al/NiCu | PP | 0.2 | 0.15 | 0.3 | 0.04 | None | NCA | A | 170 |
| | type | can | | | | | | | | | | | | |
| Example 7 | Cylindrical | Welded | Heat | Fe | Al/NiCu | PP | 0.2 | 0.15 | 0.3 | 0.04 | Negative | LCO | A | 160 |
| | type | can | | | | | | | | | collector | | | |
| Example 8 | Cylindrical | Welded | Heat | Fe | Al/NiCu | PP | 0.2 | 0.15 | 0.3 | 0.04 | Negative | LFP | A | 160 |
| | type | can | | | | | | | | | collector | | | |
| Example 9 | Cylindrical | Welded | Heat | Al | SUS | PP | 0.2 | 0.15 | 0.3 | 0.04 | Positive | NCA | A | 150 |
| | type | can | | | | | | | | | collector | | | |
| Example 10 | Cylindrica | Welded | Heat | Al | SUS | PP | 0.2 | 0.15 | 0.3 | 0.04 | Positive | LFP | A | 150 |
| | type | can | | | | | | | | | collector | | | |
| Example 11 | Coin type | Welded | Heat | SUS | Al/NiCu | PP | 0.15 | 0.1 | 0.25 | 0.04 | Negative | LCO | A | 150 |
| | | can | | | | | | | | | collector | | | |
| Comparative | Cylindrical | Welded | Heat | Fe | Al/NiCu | PP | 0.2 | 0.2 | 0.3 | 0.04 | Negative | NCA | B | 175 |
| example 1 | type | can | | | | | | | | | collector | | | |
| Comparative | Cylindrical | Welded | Heat | Fe | Al/NiCu | Silicone | 0.2 | 0.15 | 0.3 | 0.04 | Negative | NCA | E | — |
| example 2 | type | can | | | | resin | | | | | collector | | | |
| Comparative | Coin type | Welded | Heat | Fe | Al/NiCu | PP | 0.15 | 0.15 | 0.25 | 0.04 | Negative | LCO | B | 165 |
| example 3 | | can | | | | | | | | | collector | | | |
| Comparative | Cylindrical | Crimped | Pressure | Fe | Al/NiCu | PP | 0.3 | 0.2 | — | — | None | NCA | C | 200 |
| example 4 | type | can | | | | | | | | | | | | |
| Comparative | Cylindrical | Crimped | Pressure | Fe | Al/NiCu | PP | 0.3 | 0.2 | — | — | None | LFP | D | — |
| example 5 | type | can | | | | | | | | | | | | |

As indicated in Table 1, the release state of the internal pressure varied depending on the configuration of the secondary battery.

Specifically, in a case where the safety valve mechanism 91 serving as the pressure-actuated release valve was used (Comparative examples 4 and 5), upon overcharging, it was not possible to release the internal pressure, or the actuation temperature was high although it was possible to release the internal pressure.

More specifically, in a case where the positive electrode active material included the lithium compound (the composite oxide) having the layered rock-salt crystal structure (Comparative example 4), the internal pressure increased sufficiently due to generation of a large amount of gas after abnormal heat generation upon overcharging, and as a result, the release valve was actuated. However, the outer package can 10 ruptured and the actuation temperature was high. More specifically, the actuation temperature reached 200° C.

Further, in a case where the positive electrode active material included the lithium compound (the phosphoric acid compound) having the olivine crystal structure (Comparative example 5), the internal pressure did not increase sufficiently because no large amount of gas was generated upon overcharging, and as a result, the release valve failed to be actuated. However, the outer package can 10 deformed due to gas generation.

In contrast, in a case where the external terminal 30 serving as the heat-actuated release valve was used (Examples 1 to 11 and Comparative examples 1 to 3), whether the internal pressure was releasable before a rupture or deformation of the outer package can 10 upon overcharging was dependent on the configuration of the secondary battery.

More specifically, in a case where the thickness T2 of the cover part 12 was equal to the thickness T1 of the container part 11 in the secondary battery of the cylindrical type (Comparative example 1), heat was not transferred in sufficient amount to the gasket 40 upon overcharging, and thus the gasket 40 was not sufficiently heated. As a result, the release valve was actuated but with a delay, which caused a deformation of the outer package can 10 and an increase in actuation temperature. The delay in actuation of the release valve due to insufficient heating of the gasket 40 similarly occurred in a case where the thickness T2 of the cover part 12 was equal to the thickness T1 of the container part 11 in the secondary battery of the coin type (Comparative example 3). In particular, when the thicknesses T1 and T2 were equal to each other, the container part 11 was more easily deformable than the cover part 12, which made it difficult to make use of deformation of the cover part 12 to achieve an action of separating the external terminal 30 from the cover part 12. As a result, the outer package can 10 became more prone to rupture or deformation.

Further, in a case where the gasket 40 in the secondary battery of the cylindrical type included a silicone resin having a high temperature of deflection under load (Comparative example 2), the gasket 40 was not thermally deformed upon overcharging, and thus the external terminal 30 was not separated from the cover part 12. In this way, the release valve failed to be actuated, thus failing to release the internal pressure. In this case, in particular, the release valve failed to be actuated even upon an excessive increase in the internal pressure. This resulted in a rupture of the outer package can 10, causing the battery device 20 to be released from inside to outside the outer package can 10.

In contrast, in a case where the thickness T2 of the cover part 12 was smaller than the thickness T1 of the container part 11 in the secondary battery of the cylindrical type (Examples 1 to 10), a sufficient amount of heat was transferred to the gasket 40 upon overcharging, and the gasket 40 was thus sufficiently heated. As a result, the release valve was actuated to thereby achieve the release of the internal pressure. Moreover, the actuation temperature was reduced to below 200° C. The foregoing result that the gasket 40 was sufficiently heated to make it possible to release the internal pressure was obtained also in a case where the thickness T2 of the cover part 12 was smaller than the thickness T1 of the container part 11 in the secondary battery of the coin type (Example 11).

In the case where the thickness T2 of the cover part 12 was smaller than the thickness T1 of the container part 11 (Examples 1 to 11), in particular, a series of tendencies described below was obtained. Firstly, the actuation temperature decreased if the thickness T4 of the gasket 40 was smaller than the thickness T2 of the cover part 12. Secondly, the actuation temperature decreased if the thickness T4 of the gasket 40 was smaller than the thickness T3 of the external terminal 30. Thirdly, the actuation temperature decreased if the thickness T3 of the external terminal 30 was greater than the thickness T2 of the cover part 12. Fourthly, the actuation temperature decreased sufficiently if polypropylene (having a temperature of deflection under load in the range from 60° C. to 150° C. both inclusive and a melting point of 160° C.) was used as the material of the gasket 40. Fifthly, the release valve was actuated stably even if one of the outer package can 10 or the external terminal 30 included aluminum or the cladding material. Sixthly, the release valve was actuated stably even if the positive electrode 21 included the lithium compound (the phosphoric acid compound) having the olivine crystal structure.

The results presented in Table 1 indicate that, in a case where the temperature of deflection under load of the gasket 40 was in the range from 60° C. to 150° C. both inclusive and where the thickness T2 of the cover part 12 was smaller than the thickness T1 of the container part 11, the release valve (the external terminal 30) was actuated at an appropriate actuation temperature, and the internal pressure release characteristic was thus improved. Accordingly, it was possible to achieve superior safety.

Although the present technology has been described herein including with reference to one or more embodiments including Examples, the configuration of the present technology is not limited thereto, and is therefore modifiable in a variety of suitable ways.

Although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited thereto. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having a through hole;
a battery device contained inside the outer package member;
an electrode terminal disposed on an outer side of the outer package member and covering the through hole; and
an insulating member disposed between the electrode terminal and the outer package member and not covering the through hole, wherein
the outer package member includes
a container part having an opening and containing the battery device inside, and
a cover part having the through hole and closing the opening,
the container part and the cover part are joined to each other,
the insulating member has a temperature of deflection under load of greater than or equal to 60 degrees centigrade and less than or equal to 150 degrees centigrade, and
the cover part has a thickness smaller than a thickness of the container part.

2. The secondary battery according to claim 1, wherein the insulating member has a thickness smaller than the thickness of the cover part.

3. The secondary battery according to claim 1, wherein the insulating member has a thickness smaller than a thickness of the electrode terminal.

4. The secondary battery according to claim 1, wherein the electrode terminal has a thickness greater than the thickness of the cover part.

5. The secondary battery according to claim 1, wherein the insulating member has a melting point of greater than or equal to 130 degrees centigrade and less than or equal to 250 degrees centigrade.

6. The secondary battery according to claim 1, wherein the cover part has a thermal conductivity higher than a thermal conductivity of the insulating member.

7. The secondary battery according to claim 1, wherein the electrode terminal has a thermal conductivity higher than a thermal conductivity of the insulating member.

8. The secondary battery according to claim 1, wherein
the battery device includes a positive electrode and a negative electrode,
the positive electrode includes a positive electrode current collector,
the negative electrode includes a negative electrode current collector, and
one of the positive electrode current collector or the negative electrode current collector is coupled to the outer package member.

9. The secondary battery according to claim 1, wherein one of the outer package member or the electrode terminal includes aluminum, an aluminum alloy, or both.

10. The secondary battery according to claim 1, wherein
the battery device includes a positive electrode and a negative electrode,
one of the positive electrode or the negative electrode is electrically coupled to the electrode terminal, and
another of the positive electrode or the negative electrode is electrically coupled to the outer package member.

11. The secondary battery according to claim 1, wherein
the cover part includes a recessed part,
at the recessed part, the cover part is so bent as to be partly recessed toward an inside of the container part, and
the electrode terminal is disposed inside the recessed part.

12. The secondary battery according to claim 1, wherein
the battery device includes a positive electrode, and
the positive electrode includes a positive electrode active material having an olivine crystal structure.

13. The secondary battery according to claim 1, wherein the secondary battery comprises a lithium-ion secondary battery.
